(19) United States
(12) Patent Application Publication
(10) Pub. No.: US 2025/0389862 A1
(43) Pub. Date: Dec. 25, 2025

(54) Recovering Resources from a Subsurface Region

(71) Applicant: Saudi Arabian Oil Company, Dhahran (SA)

(72) Inventors: Fatai A. Anifowose, Al-Khobar (SA); Bandar Ismail Ghassal, Dhahran (SA); Abdulaziz S. Qasim, Dammam (SA); Mokhles Mustapha Mezghani, Dhahran (SA)

(21) Appl. No.: 18/753,635

(22) Filed: Jun. 25, 2024

(51) Int. Cl. G01V 1/50; E21B 49/00; G06N 3/048; G06N 3/084

(52) U.S. Cl. CPC G01V 1/50; E21B 49/00; G06N 3/048; G06N 3/084; E21B 2200/22; G01V 2210/6169; G01V 2210/64

(57) ABSTRACT

A method for recovering resources from a subsurface region that includes obtaining log data from multiple wells located in a first region, obtaining seismic data from a seismic survey of the first region, obtaining material abundance data from core samples from at least one of the wells, correlating the log-seismic data with the material abundance data, logging a second well to generate log data for the second well, obtaining seismic data from a seismic survey of a second region that includes the second well, processing the log-seismic data of the second region with a machine learning model trained on the log-seismic-abundance data of the wells in the first region to generate predicted material abundance data of the second well, and generating a pseudo-log of material abundance of the second well based at least in part on the predicted material abundance data.

### TECHNICAL FIELD

The present disclosure describes techniques for recovering resources from a subsurface region that includes wells.

### BACKGROUND

Wireline logging is a technique in the field of hydrocarbon exploration and extraction that includes lowering measurement tools into a well on a wireline to record continuous measurements of various physical properties of the rock and fluid contents of the subsurface environment. The tools can measure properties such as electrical resistivity, gamma radiation, and acoustic properties. Information obtained from wireline logs can help plan the trajectory of future drilling operations and selecting zones for hydrocarbon extraction.

Core sample extraction is a technique in the field of hydrocarbon exploration and extraction that includes extracting cylindrical sections of rock directly from the subsurface at various depths of the well. The core samples are extracted with a specialized drill bit and brought to the surface inside a core barrel, where the core sample is preserved and label according to the corresponding depth of extraction. Evaluation of the core samples provide measurements of physical rock properties that include porosity, permeability, grain density, and elemental data of the subsurface.

In reflection seismology, geologists and geophysicists perform seismic surveys to map and interpret sedimentary facies and other geologic features for applications, for example, identification of potential petroleum reservoirs. Seismic surveys are conducted by using a controlled seismic source (for example, a seismic vibrator or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources, for example, borehole logging, gravity surveys, and magnetic surveys.

### SUMMARY

This specification describes techniques that can be used for recovering resources from a subsurface region. The techniques include determining material abundance in unsampled intervals of hydrocarbon wells, where an evaluation of an amount of material, e.g., rare earth elements or other minerals, from core samples are correlated with rock properties determined by well logs and seismic surveys. Well logs can include wireline logs and logs from logging-while-drilling techniques. Wireline logs are often obtained after a well has been drilled, where one or more logging tools are lowered into the well to collect measurements corresponding to multiple properties of the subsurface including gamma ray levels, neutron porosity, density, spontaneous potential, and sonic shear. Seismic surveys of a region are obtained by measuring reflected seismic waves from a ground-level seismic source to determine properties of a subsurface by measuring seismic attributes that are sensitive to specific subsurface materials, e.g., rare earth elements and/or other minerals. In addition, core samples, often obtained while drilling, can be analyzed to evaluate multiple rock properties of the subsurface including porosity, permeability, grain density, and other elemental characteristics. The data from core samples correspond to discrete sections of wells, and sections of wells often do not have representative core samples. Well logs and seismic surveys of a region are easier to acquire and can be acquired after wells are completed; therefore, a correlation between core sample measurements and log/seismic measurements can provide an estimation of material abundance in well sections without representative core samples.

This specification describes an approach to determining a correlation between a set of material abundance measurements from core samples with a set of pseudo-logs based on a corresponding set of logs, e.g., wireline logs or logging-while-drilling logs, from one or more wells in a region and a set of seismic attributes from a seismic survey of the region. The correlation can be determined by training a machine learning model to learn a pattern between a well log that includes measurements of various subsurface properties, a predicted set of rock properties, and seismic attributes. The correlation can provide an estimation of material abundance in wells without core samples and for sections of wells without core samples. By identifying a relationship between well logs, seismic attributes, and rock properties through training a machine learning model using core sample data, well logs, and seismic attributes as training data, a predicted continuous material abundance map of a well is obtained without requiring core samples from the well.

Implementations of the systems and methods of this disclosure can provide various technical benefits. A material abundance map of a well can be obtained for a well without core samples and for sections of a well without core samples, which reduces a necessity for collecting core samples from every section of every well in a region. Using multiple rock properties inferred from well logs (e.g., pseudo-logs) and seismic attributes, a multivariate correlation between the predicted multiple rock properties and measured rock properties from core samples offers a more precise correlation compared to previous approaches that use a single variable (e.g., correlating gamma ray levels).

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of exploration activities being performed to map subsurface features of a reservoir.

FIG. 2 is a block diagram showing an example process for determining a material abundance of a subsurface.

FIG. 3 is a schematic illustrating a process for training and validating a machine learning model to predict a set of rock properties of a well.

FIG. 4 is a schematic illustrating the input data and output predictions for a machine learning model trained to predict a set of rock properties of a well.

FIG. 5 illustrates a difference between a set of core-log measurements of a well and a set of predicted values from a machine learning model for an evaluation of an abundance of titanium dioxide (TiO₂).

FIG. 6 is a schematic illustrating field operations to recover resources from a subsurface.

FIG. 7 is a diagram of an example computing system.

Like reference numbers and designations in the various drawings indicate like elements.

### DETAILED DESCRIPTION

This specification describes techniques that can be used for determining material abundance in unsampled intervals of wells, where an evaluation of an amount of material, e.g., rare earth elements or other minerals, from core samples are correlated with rock properties determined by well logs and seismic surveys. Well logs can include wireline logs and logs from logging-while-drilling techniques. Wireline logs are often obtained after a well has been drilled, where one or more logging tools are lowered into the well to collect measurements corresponding to multiple properties of the subsurface including gamma ray levels, neutron porosity, density, spontaneous potential, and sonic shear. Seismic surveys of a region are obtained by measuring reflected seismic waves from a ground-level seismic source to determine properties of a subsurface by measuring seismic attributes that are sensitive to specific subsurface materials, e.g., rare earth elements and/or other minerals. In addition, core samples, often obtained while drilling, can be analyzed to evaluate multiple rock properties of the subsurface including porosity, permeability, grain density, and other elemental characteristics. The data from core samples correspond to discrete sections of wells, and sections of wells often do not have representative core samples. Well logs, e.g., wireline logs, and seismic surveys of a region are easier to acquire and can be acquired after wells are completed; therefore, a correlation between core sample measurements and well log/seismic measurements provides an estimation of material abundance in well sections without representative core samples.

This specification describes a multivariate approach to determine a correlation between a set of rock properties from core samples with a set of pseudo-logs corresponding to the same rock properties as determined by a corresponding set of well logs from one or more wells and seismic attributes from a seismic survey of a region that includes the one or more wells. The correlation can be determined by training a machine learning model to learn a pattern between a well log and seismic attributes, where the well log includes measurements of various subsurface properties, and a set of rock properties from core samples. The correlation can provide an estimation of material abundance (e.g., an amount of rare earth elements) for wells without core samples and for sections of wells without core samples. By identifying a relationship between well logs/seismic attributes and rock properties through training a machine learning model using core sample data and well logs/seismic attributes as training data, a predicted material abundance for multiple materials is obtained without requiring core samples from additional wells.

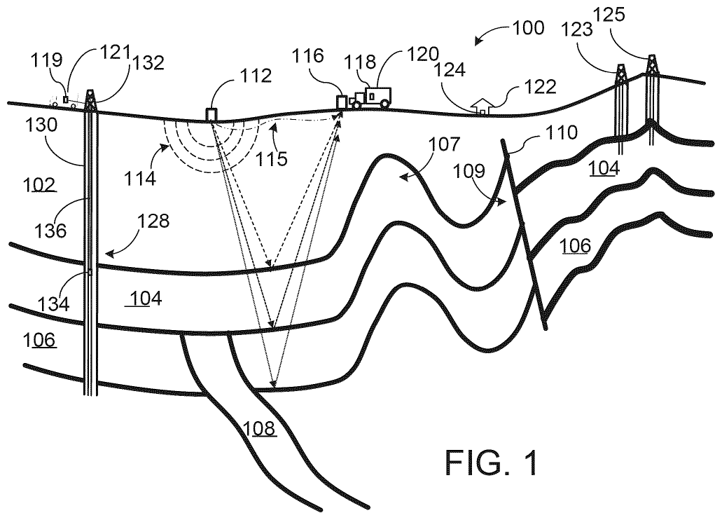

FIG. 1 is a schematic view of exploration activities being performed to map subsurface features in a subsurface formation 100. Seismic surveys along with wireline logs and core samples from wells in the subsurface can provide a comprehensive evaluation of the structure of the subsurface formation 100. For example, correlating the seismic survey with wireline logs and core samples can lead to a prediction of the subsurface rock properties at multiple depths of the subsurface, and help identify regions for further exploration and recovery of resources, e.g., hydrocarbons and minerals.

The subsurface formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106. Some layers of the subsurface formation 100 may include minerals.

Oil and gas tend to rise through permeable reservoir rock until further upward migration is blocked, for example, by the layer of impermeable cap rock 102. Seismic surveys attempt to identify locations where interaction between layers of the subsurface formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source or sources 112 are typically a line or an array of sources 112. The generated seismic waves include seismic body waves 114 that travel into the ground and seismic surface waves 115 travel along the ground surface and diminish as they get further from the surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems that provide additional information about the subsurface formation. For example, the control center 122 can receive data from a computer 119 associated with a well logging unit 121. An analysis of seismic surface waves 115 and seismic body waves 114 can result in one or more seismic attributes that correlate with properties of the subsurface region. In some cases, the seismic attributes can correlate with an abundance of hydrocarbons and/or an abundance of minerals like rare earth elements. The analysis can contribute to resource recovery efforts by providing additional data correlated with resource abundance in the subsurface.

The computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some embodiments, a wellbore 130 that has been drilled in the subsurface formation 100 is logged in a well logging operation 128. The wellbore 130 extends downhole from a wellhead 132. The wellbore 130 is a vertical wellbore but well logging can also be performed in other wellbores, for example, slanted or horizontal wellbores. In the well logging operation 128, the wellbore 130 penetrates through three layers 102, 104, and 106 of a subsurface formation 100. A control truck 121 lowers a logging tool 134 down the wellbore 130 on a wireline 136.

The logging tool 134 is string of one or more instruments with sensors operable to measure geophysical properties of the subsurface formation 100. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool consists of a piezoelectric transmitter and receiver and the time taken for the sound wave to travel the fixed distance between the two is recorded as an interval transit time.

Data acquired by the logging tool 134 can be used to inform resource recovery efforts by identifying regions with material abundance, e.g., rare earth elements and other minerals. In some cases, a logging tool can include a wireline log or a logging-while-drilling logging tool that acquires well log data during drilling.

As the logging tool 134 travels downhole, measurements of formations properties are recorded to generate a well log. In the illustrated operation, the data are recorded at the control truck 121 in real-time. Real-time data are recorded directly against measured cable depth. In some well-logging operations, the data is recorded at the logging tool 134 and downloaded later. In this approach, the downhole data and depth data are both recorded against time. The two data sets are then merged using the common time base to create an instrument response versus depth log.

In the well logging operation 128, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling. Well logging data from the well logging operation 128 can be used to inform resource recovery efforts, including a recovery of hydrocarbons and minerals like rare earth elements.

The computer systems 124 in the control center 122 can be configured to analyze, model, control, optimize, or perform management tasks of field operations associated with development and production of resources such as oil and gas from the subsurface formation 100. For example, an injection well 123 and a production well 125 extend into layer 104 of the subsurface formation 100. Based on data gathered by the exploratory field operations, the computer systems 124 can generate models such as a reservoir model for portions of the subsurface formation 100. These models can simulate the effects of production field operations (e.g., injecting water or carbon dioxide through the injection well 123 to increase the production of hydrocarbons through the production well 125). The simulations can be used to plan and, in some instances, control field operations (e.g., the operation of pumps associated with the injection well 123 and the production well 125).

In some embodiments, results generated by the computer systems 124 may be displayed for user viewing using local or remote monitors or other display units. One approach to analyzing seismic data is to associate the data with portions of a seismic cube representing the subsurface formation 100. The seismic cube can also display results of the analysis of the seismic data associated with the seismic survey.

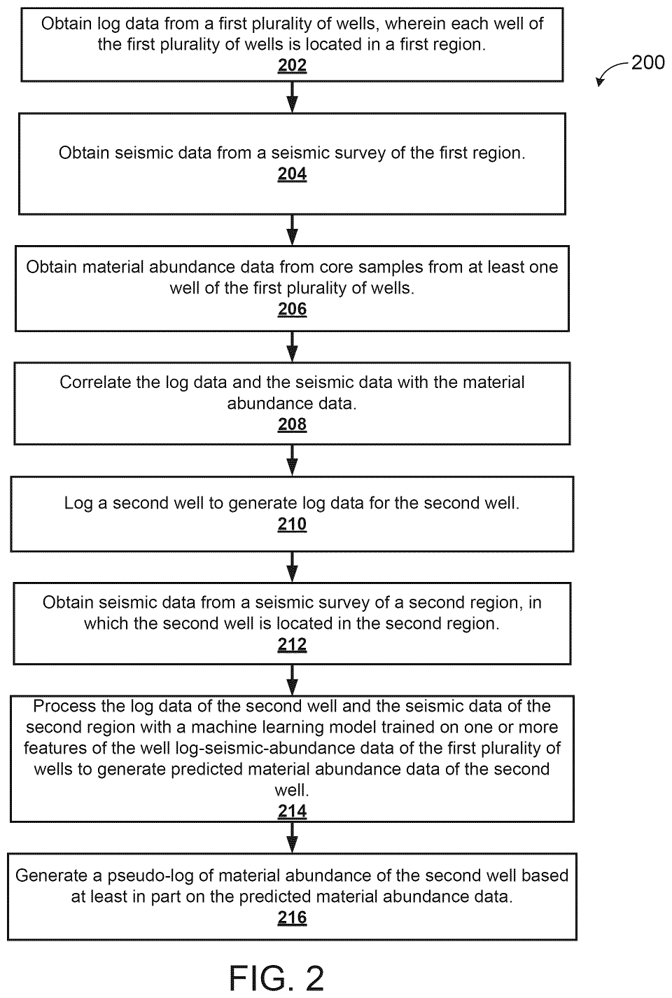

FIG. 2 is a block diagram illustrating an example process 200 for generating a pseudo-log of material abundance of a well using a machine learning model trained using correlations between well logs/seismic data and core samples from one or more wells, according to some implementations of the present disclosure. For clarity of presentation, the description that follows generally describes process 200 in the context of the other figures in this description. In some implementations, various steps of process 200 can be run in parallel, in combination, in loops, or in any order.

The process 200 includes a system that obtains (202) log data from one or more first wells. Logging, e.g., wireline logging, is a method used to obtain detailed reservoir rock properties of a subsurface formation (i.e., subsurface formation 100) in a well. The method includes lowering a logging tool, where the logging tool can be a string of measurement instruments, down a well (i.e., wellbore 130) on a wireline. The wireline is a thin cable used to lower and raise the logging tool. In some cases, the wireline logs are stored in a database from previous logging activities. In some other cases, the logs are obtained from new wells using logging-while-drilling techniques.

In some implementations, the logs from each of the one or more first wells provide measurements of properties of the corresponding subsurface formation that include gamma ray emission, neutron porosity, density, spontaneous potential, sonic compression, and sonic shear. Measurement devices on the logging tool that is lowered down each of the one or more first wells obtain the properties of the corresponding subsurface formation. For example, a gamma ray logging tool that can include a scintillation detector can evaluate the gamma ray emission of a portion of the subsurface by measuring the natural radioactivity of the subsurface material. In some cases, shale and non-shale formations emit different levels of radioactivity, which can provide insight into the composition of the subsurface as a function of depth. As another example, by evaluating the thermalization rate of neutrons sent through the subsurface material, the neutron porosity of a portion of the subsurface can be obtained, where a helium-3 (He-3) detector measures the thermalized neutrons and an americium-beryllium (Am-Be) neutron source generates the emitted neutrons. In general, the logging tool can include one or more source of neutrons, acoustic signals, electrical current and detectors to detect radioactivity, reflected sonic waves, electrical resistivity, or any other source or detector to evaluate properties of the subsurface formation.

The logs of the subsurface formation from each of the one or more first wells include one or more sequences of ordered pairs, where each sequence corresponds to a physical property of the subsurface as evaluated by a measurement device on the logging tool. Each ordered pair includes a depth value and a measured physical property value. For example, an ordered pair corresponding to the gamma ray emission at a particular well of the one or more first wells at a particular depth di is (di, gi), where gi is the measured gamma ray emission at depth di according to the well log. In this example, the sequence of ordered pairs corresponding to the gamma ray emission at all depths of the particular well includes all values of di corresponding to the full measured depth of the first well. The logging tool can obtain a similar sequence of ordered pairs for each physical property of the subsurface for the particular well, and the same set of sequences of ordered pairs for each well of the one or more first wells.

For each well of the one or more wells in which log data is collected, the system obtains (204) seismic data from a seismic survey of a respective region, in which the well is located in the respective region. Detail about seismic sources and measurement is provided above in relation to FIG. 1.

Seismic data, also referred to as seismic attributes, obtained from a seismic survey of a region include energy half-time, instantaneous frequency, time dip, dip azimuth, dominant frequency, positive-to-negative phase ratio, decile frequency, frequency-to-band ratio, spectral attribute central frequency, and spectral attribute dominant frequency. Each seismic attribute can be inferred by measuring and analyzing reflected seismic waves as the waves are propagated through a subsurface of the region. In some implementations, one or more seismic attributes are sensitive to particular elements, e.g., rare earth elements and other minerals. In particular, measured seismic attributes, e.g., energy half-time, can depend on an abundance of a particular element or mineral present in the subsurface.

In some implementations, the system determines a three-dimensional seismic volume of a region, in which a seismic attribute, e.g., energy half-time, is mapped across the region. The location of each well of the one or more first wells can be mapped to a coordinate of the three-dimensional seismic volume of the region, which provides a determination of the seismic attribute at the location of each well.

To generate seismic data indicative of subsurface conditions, the system, e.g., a computer system that executes one or more data processing tasks, processes the seismic data with various signal processing techniques to improve signal-to-noise ratio and to isolate a seismic reflection of interest, (e.g., a seismic reflection from a particular subsurface boundary). To process the seismic data, the system first collects raw seismic data from a seismic survey of a region, as described in relation to FIG. 1. The processing techniques include filtering, deconvolution, amplitude renormalization, and other data processing techniques. After processing, the system formats the seismic data in a format suitable for training a machine learning model, e.g., a multi-dimensional array in which each matrix element corresponds to a particular seismic attribute of a particular location and time.

As described below, the system processes attributes of the seismic data with a machine learning model, along with other attributes from other data sources, to predict a material abundance of a subsurface. The seismic attributes include signal amplitude, signal phase, signal frequency, impedance, signal attenuation, and signal velocity. The signal is a seismic signal that is emitted from a seismic source and detected by a seismic sensor, as described in relation to FIG. 1. The signal amplitude is a strength of the seismic signal, in which the amplitude is indicative of changes in lithology and/or fluid content of a subsurface region. The signal phase is a relative position of a wave cycle of the seismic signal, in which the signal phase is indicative of a geological boundary of the subsurface. The seismic impedance is a product of rock density and seismic velocity and is indicative of rock properties. The signal attenuation is a loss of energy of the seismic signal between a source and a sensor. The seismic signal can lose energy due to various factors, e.g., absorption and/or scattering, and the attenuation is indicative of a porosity of subsurface material. The signal velocity is a speed of seismic waves emitted from the seismic source and is indicative of a rock type and fluid content of a subsurface.

The system obtains (206) material abundance data from core samples from the one or more first wells. The material abundance data can be stored in a database and accessed from the database or collected directly from wells. Core samples provide direct physical measurements of the subsurface rock formation. In some cases, the core samples are cylindrical sections of rock extracted from the subsurface through drilling operations. Core samples can provide a measurement of the subsurface porosity, permeability, grain density, and elemental data properties at the depth from which the core sample is collected.

In some implementations, an evaluation of material abundance of core samples includes measurements using one or more of X-ray diffraction, X-ray fluorescence, and inductively coupled plasma mass spectrometry. The core samples can include measurements an abundance of rare earth elements which include a set of 17 metallic elements that include 15 lanthanides, scandium, and yttrium. Rare earth elements are commonly used for energy transition processes and as components of batteries. In addition, rare earth elements are components of various electronic devices including cellular telephones, electric vehicles, and flat-screen monitors. Rare earth element abundance can be measured in terms of parts per million (ppm) and are often measured alongside other elements in core samples that are retrieved from subsurface wells. In addition to rare earth elements, material abundance of additional minerals are determined through core samples, including lithium, vanadium, and sodium.

The system correlates (208) the logs and the seismic data with the measured reservoir rock properties, e.g., the core samples, from at least one well of the first plurality of wells. In some cases, the measured values from the logs are different from the measured values from the core samples. However, one or more measured values from the logs can be correlated to one or more measured values from the core samples. For example, as an example of a well log, a neutron log may correlate closely with a porosity measurement of a core sample at corresponding depths, because the values measured in a neutron log can be affected by the porosity of the subsurface.

The system trains a machine learning model to identify correlations between the well logs/seismic data and the measured reservoir rock properties from core samples. In some implementations, the machine learning model is an artificial neural network. The artificial neural network includes one or more hidden layers, the one or more hidden layers including a summation layer as a linear function and an activation layer as a sigmoid function. In addition, in some implementations, the system trains the artificial neural network using a Levenberg-Marquardt algorithm and a Bayesian regularization backpropagation algorithm. The system iteratively determines the weights of each layer of the artificial neural network by minimizing a difference between the predicted rock properties, where the predicted rock properties are the outputs of the artificial neural network, and the measured rock properties from the core samples.

In general, and specifically for the case of the artificial neural network, the system trains and validates the machine learning on a dataset that includes historical log data (e.g., wireline logs from the one or more first wells), seismic data (e.g., seismic attributes obtained from a seismic survey of a region), and a corresponding core-log dataset (i.e., the core sample measurements from each of the one or more first wells located in the region). The core-log data from the one or more first wells represent a set of ground truth values corresponding to a set of predicted rock properties.

The well log-seismic-core dataset is a multi-variable dataset with a complex relationship between variables. The well log dataset can include multiple logs of various types, e.g., gamma ray logs, neutron porosity logs, sonic compression logs, etc. The seismic dataset can include multiple seismic attributes of various types, e.g., energy half-time, spectral attribute central frequency, spectral attribute dominant frequency, etc. The core sample data set ca include multiple material attribute measurements that directly correspond to an evaluation of material abundance, e.g., x-ray diffraction, x-ray fluorescence, etc.

One or more features are determined to be predictive features of an abundance of a particular material. In other words, a particular combination of seismic attributes and log data types can be more “predictive”, e.g., provide more accurate predictions of material abundance of a particular material, than other combinations. Feature selection is a process of determining features and/or combination of features that provide an optimal prediction of material abundance, e.g., an amount of rare earth elements and/or minerals in the subsurface. Feature extraction techniques include an analysis of a correlation coefficient for various combinations of features, neighborhood component analysis, fuzzy ranking, forward selection, backward elimination, and forward selection with backward elimination. Particular materials, e.g., rare earth elements, may required may be predicted with a particular combination of features, and other materials, e.g., other minerals, may be predicted with a different particular combination of features. A feature selection process, using one of the techniques mentioned above, can be performed for training a machine learning model to predict each material type. The features, as determined by the feature selection process, are processed by one or more machine learning models as part of the training process to determine one or more trained machine learning models. The one or more trained machine learning models process the same selected features that are based on data from new wells during the implementation of the trained machine learning models.

In some implementations, the system performs seismic inversion to the seismic data to prepare the data to be processed by the one or more machine learning models. The seismic inversion process can convert seismic reflection data, e.g., data indicative of seismic waves reflected from subsurface features, into quantitative rock properties, e.g., an amount of a particular material.

In some implementations, seismic inversion includes solving an inverse analytical function by transforming seismic traces, e.g., seismic data, represented in a time domain, e.g., a measurement time of a reflected seismic wave, to a depth domain, e.g., a depth from the surface. For example, the system can transform a seismic tract indicative of an amplitude or phase of a seismic wave into an estimate of a rock property like acoustic impedance, density, or porosity. In some cases, the rock property is indicative of lithology and/or fluid content of the subsurface region.

Seismic inversion techniques can include a post-stack, pre-stack, or an angle-dependent inversion. Post-stack inversion includes combining spatial and temporal distributions of multiple seismic parameters before inverting the seismic parameters to rock properties. Pre-stack includes inverting the seismic data associated with each seismic parameter before inverting the seismic parameters into rock properties. Angle-dependent seismic inversion takes into account an angle of incidence of seismic waves with subsurface features.

In some implementations, multiple seismic features are combined, e.g., a weighted sum, to generate a combined seismic parameter. For example, the system can consider an attraction index that represents a combination of seismic amplitude, seismic phase, and frequency attributes to highlight particular areas of geological interest. As another example, the system can consider a parameter combination that includes a combination of fuse impedance and velocity attributes to identify potential hydrocarbon reservoirs.

In addition, and/or alternatively to seismic inversion, the system performs seismic facies classification with an unsupervised machine learning technique. The seismic facies classification process results in a correlation of rock types and/or depositional environments with seismic attributes, e.g., seismic reflection amplitude, phase, velocity, etc.

In some implementations, the system performs feature scaling and/or normalization of the seismic data to prepare the data for training a machine learning model. The system performs these techniques such that each feature contribute equally and/or according to a particular pre-defined feature-importance specification, to the prediction of material abundance. Some machine learning algorithms, e.g., support vector machines and neural networks are sensitive to the scale of the training data, e.g., the magnitudes of the training data items. In some cases, machine learning models demonstrate better performance if trained on diverse input features. Combining seismic features, as described above, can enhance machine learning performance for machine learning models trained with seismic data.

In some implementations, the system implements a texture analysis of seismic data. Texture analysis includes quantifying a spatial arrangement, e.g., a spatial distribution, of seismic features. For example, a spatial distribution of seismic features can be determined with techniques like co-occurrence matrices, wavelet transformations, and/or fractal analysis. In some cases, texture attributes, which reveal subtle patterns in subsurface properties, can provide information about heterogeneity, layering, and fault/fracture networks of the subsurface. Texture attributes can be considered with traditional seismic attributes to enrich a particular training data set.

In some implementations, the system trains one or more machine learning models that output a correlation between seismic attributes, log data, and core sample data. In some cases, one or more machine learning model implements a deep learning architecture, e.g., a convolutional neural network or a recurrent neural network. Convolutional neural networks are often used for feature extraction from images, e.g., a seismic survey of a region. Recurrent neural networks are often used for sequential data, e.g., time series of seismic traces. A combination of both convolutional neural networks and recurrent neural networks can provide a flexible machine learning model framework for training on dynamic seismic data.

In some implementations, the system implements a transfer learning protocol. Transfer learning includes adapting pre-trained deep learning models, e.g., from a computer vision task, to seismic data. The model that is trained specifically for a different task is fine-tuned on a different task using a new set of training data, e.g., seismic data. In some cases, transfer learning includes leveraging knowledge obtained from large datasets to improve predictive performance on smaller, domain-specific datasets.

In some implementations, the system includes uncertainty estimates into the training data, e.g., the seismic data, the log data, and/or the core log data. Uncertainty estimates can take the form of a Bayesian neural network and/or a Monte Carlo simulation that can provide probabilistic predictions. In some cases, an understanding of uncertainty helps decision makers assess risk and make informed choices during exploration and/or reservoir management.

The system logs (210) a second well to generate log data for the second well. The logging tool is described in detail above in relation to FIG. 1.

The system obtains (212) seismic data from a seismic survey of a second region, in which the second well is located in the second region. In some cases, the second well is located in the first region. In this case, the second region is overlapping with the first region, and as long as the seismic survey of the first region includes the location of the second well, the seismic survey of the second region is the same as the seismic survey of the first region. If the second well is not located in the first region, a new seismic survey of the second region is obtained using a process as described in relation to FIG. 1.

The system processes (214) the log data of the second well and the seismic data of the second region with a machine learning model trained on one or more features of the well loge-seismic-abundance data of the first plurality of wells to generate predicted material abundance data of the second well. The machine learning model processes the input data, e.g., the log data and the seismic data, in relation to the second well and predicts one or more reservoir rock properties data, e.g., an abundance of rare earth elements.

In some implementations, the machine learning model is an artificial neural network. The artificial neural network includes a set of parameters that transforms log/seismic data obtained from the second well into a predicted set of rock properties of the second well, where the parameters of the neural network are learned from the correlation between the logs/seismic data and rock properties from core samples from the one or more first wells.

The system generates (216) a pseudo-log of material abundance of the second well based at least in part on the predicted material abundance data. The output of the machine learning model is a continuous representation of one or more predicted rock properties, e.g., an abundance of a rare earth element, of the second well. The continuous representation is a pseudo-log, where the pseudo-log is a continuous representation of a predicted physical property of the subsurface.

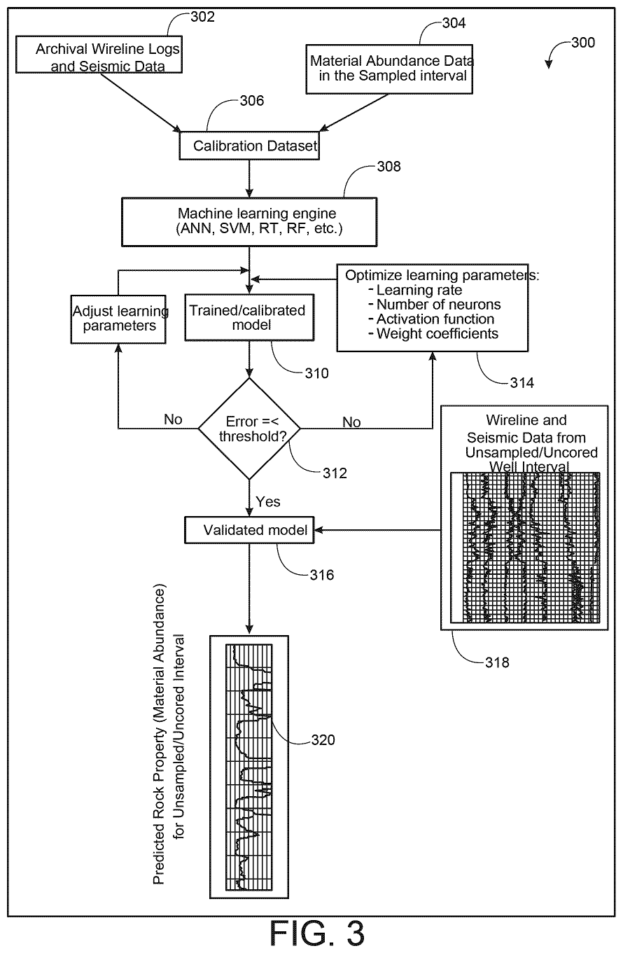

FIG. 3 is a schematic that describes a system 300, where the system 300 implements a series of steps to train a machine learning model to correlate a set of logs and seismic data 302 from one or more first wells with a set of material abundance data from core samples 304 from the one or more first wells.

For each of the one or more first wells, the system 300 combines a dataset of logs and seismic data 302 (e.g., in some cases archival wireline logs and/or archival seismic data) and a data set of material abundance (e.g., material abundance of a rare earth element) from core samples 304 in the same sampled interval as the logs to form a calibration dataset 306. In some cases, the core samples 304 that produce the material abundance data are sampled from discrete locations in the well at various depths. Contrastingly, e logs (i.e., the logs of the logs and seismic data 302) are often represented as continuous distributions along the depth of the well as the logging tool can evaluate subsurface properties at precise depth intervals. Similarly, seismic attributes represented in the seismic data of the logs and seismic data 302 are represented as continuous distributions of attributes in a three dimensional volume.

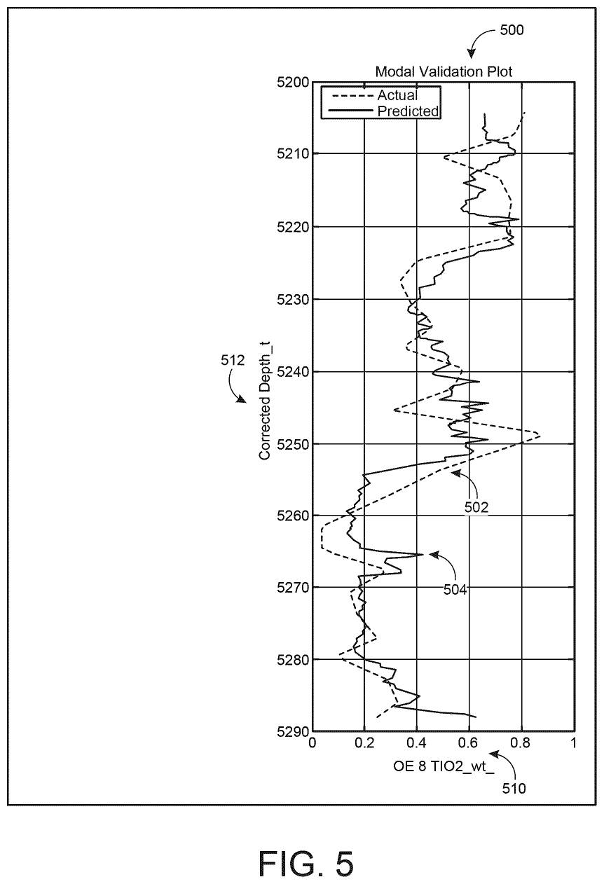

The system 300 can use the calibration dataset 306 to train a machine learning model 308 to determine a correlation between the logs and seismic data 302 and core sample 304 dataset. In some implementations, the system 300 can configure the machine learning model 308 as an artificial neural network, a support vector machine, a regression tree, a random forest, an extreme learning algorithm, or type I and type II fuzzy logic. Regardless of the specific architecture used as the machine learning model 308, the system 300 implements a training procedure to determine the parameters of the machine learning model 308 that can be used to map an input log and/or seismic data attribute to an output set of physical rock properties, e.g., a material abundance associated with a particular rare earth element or mineral. In addition, regardless of the specific architecture used as the machine learning model 308, the system 300 uses the logs and seismic data 302 of the calibration dataset 306 as a source of the input features, as described below in relation to FIG. 5, to predict a representation of the ground truth values, where the ground truth values are represented by the core sample 304 dataset. The machine learning model generates a continuous representation of material abundance along the main axis of the well.

The system can initialize the parameters of the machine learning model, where the initialization can be done randomly or using any other technique. In a first training run, machine learning model 308 generates an output of predicted material abundance 310 and the system 300 determines an error between the values of the predicted rock properties 310 and the ground truth values of the core samples 304 dataset from the calibration dataset 306. For example, the system 300 can determine the error by evaluating the mean square error between the predicted rock properties 310 and the core sample 304 dataset at one or more depths that corresponds to a well from the set of one or more first wells that corresponds to the first training run.

In some implementations, the system 300 can split the calibration dataset 306 into a training dataset and a validation dataset. The training dataset is a first subset of the calibration dataset 306, and the system 300 can use it to train the artificial neural network. The validation dataset is a second subset of the calibration dataset 306, and the system 300 can use it to validate a set of outputs of the artificial neural network.

If the error is greater than a defined error threshold 312, the system 300 can adjust the weights such that it reduces the error on a subsequent training run (i.e., a training run corresponding to a second well of the one or more first wells). In addition, the system 300 can optimize a set of learning parameters 314 such as the learning rate, the number of neurons in the case of a neural network machine learning model, the activation function in the case of a neural network machine learning model, and the weights of the machine learning model. In the case of an artificial neural network architecture as an implementation of the machine learning model 308, the artificial neural network can include one or more hidden layers, where the one or more hidden layers includes a summation layer with a linear function and an activation layer with a sigmoid function. In addition, the system 300 can train the artificial neural using a Levenberg-Marquardt algorithm and a Bayesian regularization backpropagation algorithm, where the system 300 adjusts the weights of each layer of the artificial neural network according to the implemented training algorithms.

If the error is less than or equal to the defined error threshold 312, the training process is complete and the system 300 considers the weights of the machine learning model 308 to be learned. The system 300 can use the validated machine learning model 316 to determine a predicted material abundance based on an input log and/or seismic data. For example, the validated machine learning model 316 can process a log and seismic data from a unsampled or un-cored well interval 318 to generate a predicted material abundance distribution 320 from the same interval.

As new loge data and/or seismic data and corresponding core samples are available, the system 300 can retrain the artificial neural network with new training data, where the training data is a subset of an updated calibration dataset (i.e., calibration dataset 306) to update a set of weights corresponding to a nonlinear function of the artificial neural network.

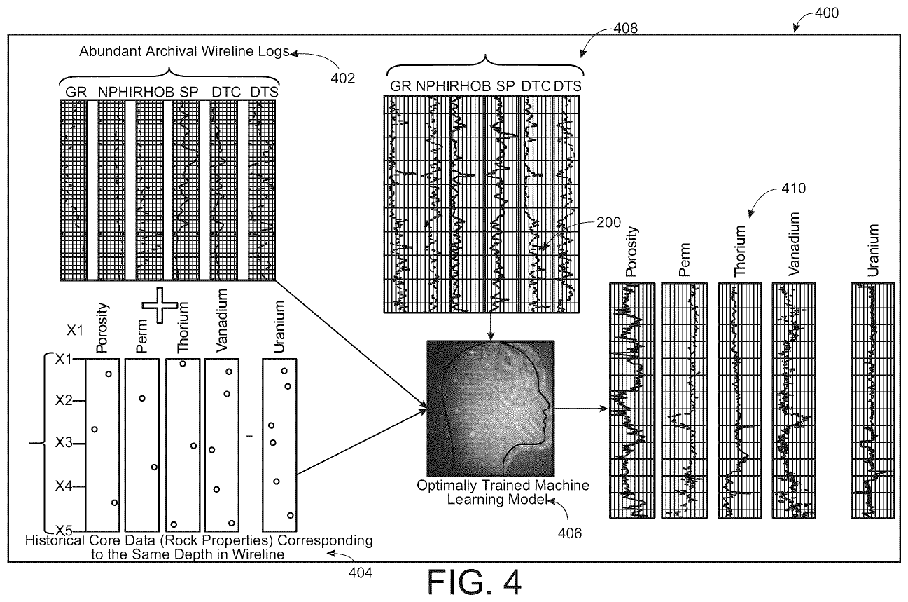

FIG. 4 is an illustration of the training data used to train the machine learning model and the input and output data processed by the trained machine learning model. As described in relation to FIG. 3, the machine learning model is trained on a calibration dataset (i.e., the calibration dataset 306), where the calibration dataset includes logs/seismic data and corresponding core samples of the one or more first wells.

A set of logs and seismic data 402 corresponding to a location of a first well of the one or more first wells is an example of one of the entries of the calibration dataset used to train the machine learning model 404. The set of logs and seismic data 402 can include logs obtained from multiple logging tools to reflect log parameters such as gamma ray (GR), neutron porosity (NPHI), density (RHOB), spontaneous potential (SP), sonic compression (DTC), and sonic shear (DTS). Each log of the set of logs and seismic data 402 displays a vertical axis that represents the well depth or distance along a main axis of the well, and a horizontal axis that represents the value of the corresponding log or seismic parameter. In some implementations, the set of logs of the logs and seismic data 402 is an example of a set of logs from a log archive, e.g., an archive of wireline logs.

A set of core samples 404 corresponding to the first well of the one or more first wells is an example of an entry of the calibration dataset used to train the machine learning model 404, where the set of core samples 404 corresponds to the same first well described by the set of logs 402. The set of core samples 404 include measurements of rock properties, e.g., material abundance data, of the subsurface such as elemental composition (i.e., Thorium, Vanadium, and Uranium). Each core sample from the set of core samples 404 displays a vertical axis that represents the well depth and a horizontal axis that represents the value of the corresponding rock property. The well depth represented by the vertical axis is the same well depth as depicted in the set of logs and seismic data 402.

The set of logs and seismic data 402 and the set of core samples 404, each corresponding to the same first well of the one or more first wells, is an example entry of a training dataset used to train the machine learning model 406. The set of core samples 404 represents the ground truth data, where the machine learning model 406 learns to correlate the features of an input set of logs and seismic data 408 to predict an output representation of material abundance 410.

In some implementations, the input set of logs and seismic data 408 may be from an input well with no core samples or un-cored intervals. The machine learning model 406 can generate the output representation of material abundance 410 for the entire input well despite not being provided the core samples for the entire depth of the input well.

FIG. 5 is a plot 500 of a first dataset 502 that represents measured values at multiple depths of TiO₂ in a subsurface of a well obtained through core samples and a second dataset 504 that represents predicted values at multiple depths of TiO₂ in the subsurface of the well obtained through processing a wireline log with a machine learning model.

The horizontal axis 510 represents the measured value of TiO₂ in the subsurface and the vertical axis 512 represents the well depth where the logging tool obtained the wireline log measurement and core extraction tool obtained the core sample. The plot 500 displays the two datasets (the first dataset 502 and the second dataset 504) on the same axis to demonstrate a difference between the two datasets.

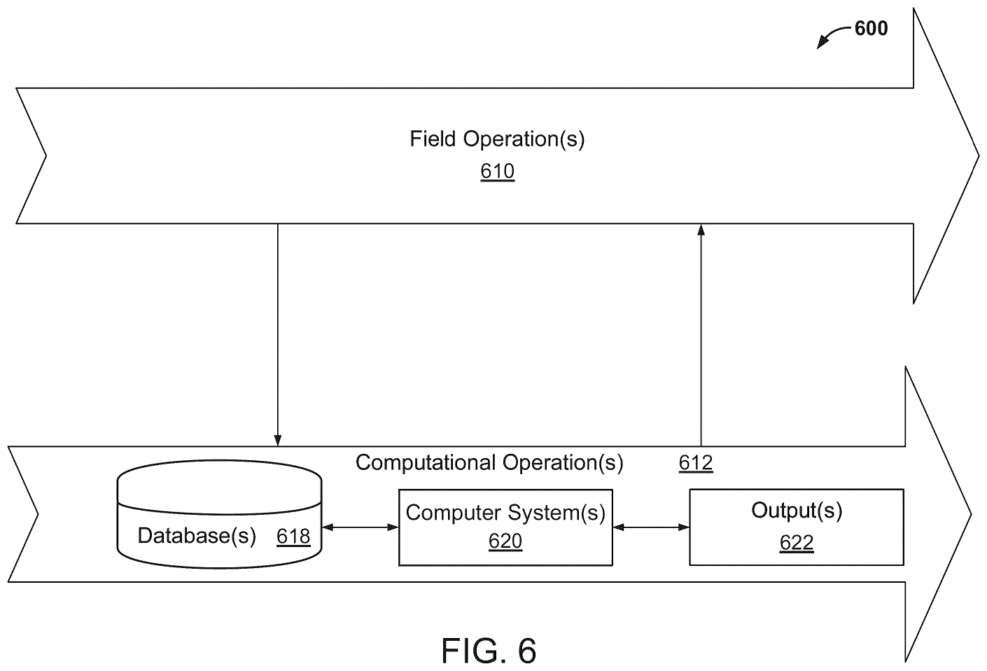

FIG. 6 illustrates hydrocarbon production operations 900 that include both one or more field operations 610 and one or more computational operations 612, which exchange information and control exploration to produce hydrocarbons. In some implementations, outputs of techniques of the present disclosure (e.g., the method 200) can be performed before, during, or in combination with the hydrocarbon production operations 600, specifically, for example, either as field operations 610 or computational operations 612, or both. For example, the process 200 collect data during field operations, processes the data in computational operations, and can determine locations to perform additional field operations.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively, or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling techniques which incorporate logging tools into the drill string. Logging-while-drilling techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 10 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

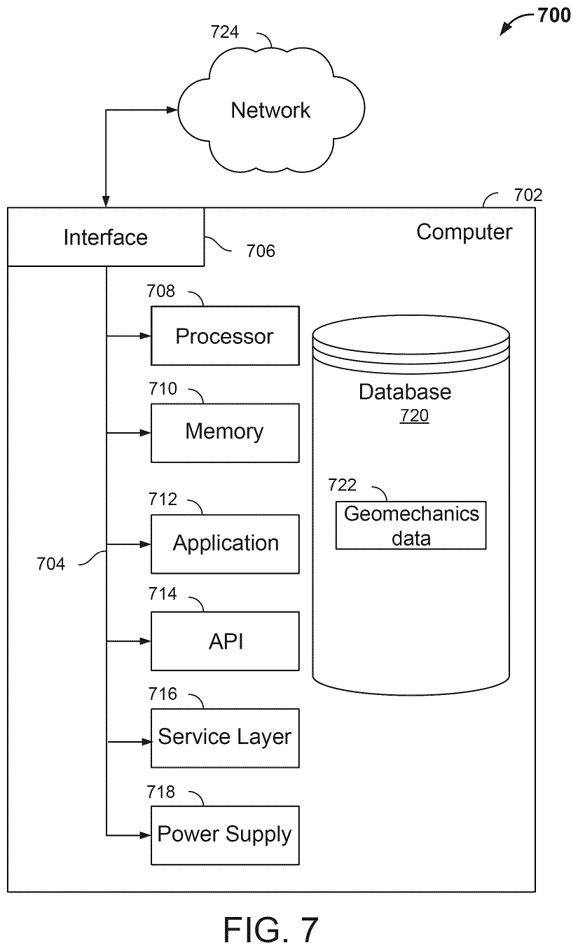

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 724. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 724 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 704. In some implementations, any or all of the components of the computer 702, including hardware or software components, can interface with each other or the interface 706 (or a combination of both), over the system bus 704. Interfaces can use an application programming interface (API) 714, a service layer 716, or a combination of the API 714 and service layer 716. The API 714 can include specifications for routines, data structures, and object classes. The API 714 can be either computer-language independent or dependent. The API 714 can refer to a complete interface, a single function, or a set of APIs.

The service layer 716 can provide software services to the computer 702 and other components (whether illustrated or not) that are communicably coupled to the computer 702. The functionality of the computer 702 can be accessible for all service consumers using this service layer. Software services, such as those provided by the service layer 716, can provide reusable, defined functionalities through a defined interface. For example, the interface can be software written in JAVA, C++, or a language providing data in extensible markup language (XML) format. While illustrated as an integrated component of the computer 702, in alternative implementations, the API 714 or the service layer 716 can be stand-alone components in relation to other components of the computer 702 and other components communicably coupled to the computer 702. Moreover, any or all parts of the API 714 or the service layer 716 can be implemented as child or sub-modules of another software module, enterprise application, or hardware module without departing from the scope of the present disclosure.

The computer 702 includes an interface 706. Although illustrated as a single interface 706 in FIG. 7, two or more interfaces 706 can be used according to implementations of the computer 702 and the described functionality. The interface 706 can be used by the computer 702 for communicating with other systems that are connected to the network 724 (whether illustrated or not) in a distributed environment. Generally, the interface 706 can include, or be implemented using, logic encoded in software or hardware (or a combination of software and hardware) operable to communicate with the network 724. More specifically, the interface 706 can include software supporting one or more communication protocols associated with communications. As such, the network 724 or the interface's hardware can be operable to communicate physical signals within and outside of the illustrated computer 702.

The computer 702 includes a processor 708. Although illustrated as a single processor 708 in FIG. 7, two or more processors 708 can be used according to implementations of the computer 702 and the described functionality. Generally, the processor 708 can execute instructions and can manipulate data to perform the operations of the computer 702, including operations using algorithms, methods, functions, processes, flows, and procedures as described in the present disclosure.

The computer 702 also includes a database 720 that can hold data (such geomechanics data 722) for the computer 702 and other components connected to the network 724 (whether illustrated or not). For example, database 720 can be in-memory or a database storing data consistent with the present disclosure. In some implementations, database 720 can be a combination of two or more different database types (for example, hybrid in-memory and conventional databases) according to implementations of the computer 702 and the described functionality. Although illustrated as a single database 720 in FIG. 7, two or more databases (of the same, different, or combination of types) can be used according to implementations of the computer 702 and the described functionality. While database 720 is illustrated as an internal component of the computer 702, in alternative implementations, database 720 can be external to the computer 702.

The computer 702 also includes a memory 710 that can hold data for the computer 702 or a combination of components connected to the network 724 (whether illustrated or not). Memory 710 can store any data consistent with the present disclosure. In some implementations, memory 710 can be a combination of two or more different types of memory (for example, a combination of semiconductor and magnetic storage) according to implementations of the computer 702 and the described functionality. Although illustrated as a single memory 710 in FIG. 7, two or more memories 710 (of the same, different, or combination of types) can be used according to implementations of the computer 702 and the described functionality. While memory 710 is illustrated as an internal component of the computer 702, in alternative implementations, memory 710 can be external to the computer 702.

The application 712 can be an algorithmic software engine providing functionality according to implementations of the computer 702 and the described functionality. For example, application 712 can serve as one or more components, modules, or applications. Further, although illustrated as a single application 712, the application 712 can be implemented as multiple applications 718 on the computer 702. In addition, although illustrated as internal to the computer 702, in alternative implementations, the application 712 can be external to the computer 702.

The computer 702 can also include a power supply 718. The power supply 718 can include a rechargeable or non-rechargeable battery that can be configured to be either user- or non-user-replaceable. In some implementations, the power supply 718 can include power-conversion and management circuits, including recharging, standby, and power management functionalities. In some implementations, the power-supply 718 can include a power plug to allow the computer 702 to be plugged into a wall socket or a power source to, for example, power the computer 702 or recharge a rechargeable battery.

There can be any number of computers 702 associated with, or external to, a computer system including the computer 702, with each computer 702 communicating over network 724. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

### Examples

In some implementations, methods for recovering resources from a subsurface region include (i) obtaining log data from a plurality of first wells, wherein each well of the plurality of wells is located in a first region, (ii) obtaining seismic data from a seismic survey of the first region, (iii) obtaining material abundance data from core samples from at least one well of the plurality of first wells, (iv) correlating the log data and the seismic data with the material abundance data, (v) logging a second well to generate log data for the second well, (vi) obtaining seismic data from a seismic survey of a second region, wherein the second well is located in the second region, (vii) processing the log data of the second well and the seismic data of the second region with a machine learning model trained on one or more features of the well log-seismic-abundance data of the one or more first wells in the first region to generate predicted material abundance data of the second well, and (viii) generating a pseudo-log of material abundance of the second well based at least in part on the predicted material abundance data.

In an example implementation combinable with any other implementation, the material abundance data represent an abundance of one or more minerals, wherein the one or more minerals include one or more rare earth elements.

In an example implementation combinable with any other implementation, the machine learning model generates a continuous set of predicted material abundance data along the main axis of the well.

In an example implementation combinable with any other implementation, the machine learning model is an artificial neural network.

In an example implementation combinable with any other implementation, the artificial neural network includes one or more hidden layers, the one or more hidden layers including a summation layer comprising a linear function and an activation layer comprising a sigmoid function.

In an example implementation combinable with any other implementation, the artificial neural network is trained using a Levenberg-Marquardt algorithm and a Bayesian regularization backpropagation algorithm.

In an example implementation combinable with any other implementation, a dataset comprising log data from one or more wells, seismic data from a seismic survey of a region that includes a location of the one or more wells, and a corresponding core sample dataset from the one or more wells are used to train and validate the artificial neural network, the log data and the seismic data representing input data processed by the artificial neural network, the core sample data representing a set of ground truth values corresponding to a set of predicted rock values.

In an example implementation combinable with any other implementation, the dataset is split into a training dataset and a validation dataset, the training dataset used to train the artificial neural network, the validation dataset used to validate a set of outputs of the artificial neural network.

In an example implementation combinable with any other implementation, the artificial neural network is retrained with new training data to update a set of weights corresponding to a nonlinear function of the artificial neural network.

In some implementations, methods for exploring a reservoir for determining material abundance include (i) obtaining log data from a well, wherein the well is located in a region, (ii) obtaining seismic data from a seismic survey of the region, (iii) processing the log data and the seismic data using a machine learning model to generate a representation of material abundance of the well, (iv) generating a pseudo-log of material abundance of the second well based at least in part on the predicted material abundance data.

In an example implementation combinable with any other implementation, the material abundance data represent an abundance of one or more minerals, wherein the one or more minerals include one or more rare earth elements.

In an example implementation combinable with any other implementation, the machine learning model generates a continuous set of predicted material abundance data along the main axis of the well.

In an example implementation combinable with any other implementation, the machine learning model is an artificial neural network.

In an example implementation combinable with any other implementation, the artificial neural network includes one or more hidden layers, the one or more hidden layers including a summation layer comprising a linear function and an activation layer comprising a sigmoid function.

In an example implementation combinable with any other implementation, the artificial neural network is trained using a Levenberg-Marquardt algorithm and a Bayesian regularization backpropagation algorithm.

In an example implementation combinable with any other implementation, a dataset comprising log data from one or more wells, seismic data from a seismic survey of a region that includes a location of the one or more wells, and a corresponding core sample dataset from the one or more wells are used to train and validate the artificial neural network, the log data and the seismic data representing input data processed by the artificial neural network, the core sample data representing a set of ground truth values corresponding to a set of predicted rock values.

In an example implementation combinable with any other implementation, the dataset is split into a training dataset and a validation dataset, the training dataset used to train the artificial neural network, the validation dataset used to validate a set of outputs of the artificial neural network.

In an example implementation combinable with any other implementation, the artificial neural network is retrained with new training data to update a set of weights corresponding to a nonlinear function of the artificial neural network.

What is claimed is:

1. A method for recovering resources from a subsurface region, the method comprising:
obtaining log data from a plurality of first wells, wherein each well of the plurality of wells is located in a first region;
obtaining seismic data from a seismic survey of the first region;
obtaining material abundance data from core samples from at least one well of the plurality of first wells;
correlating the log data and the seismic data with the material abundance data;
logging a second well to generate log data for the second well;
obtaining seismic data from a seismic survey of a second region, wherein the second well is located in the second region;
processing the log data of the second well and the seismic data of the second region with a machine learning model trained on one or more features of the well log-seismic-abundance data of the one or more first wells in the first region to generate predicted material abundance data of the second well; and
generating a pseudo-log of material abundance of the second well based at least in part on the predicted material abundance data.

2. The method of claim 1, wherein the material abundance data represent an abundance of one or more minerals, wherein the one or more minerals include one or more rare earth elements.

3. The method of claim 1, wherein the machine learning model generates a continuous set of predicted material abundance data along the main axis of the well.

4. The method of claim 1, wherein the machine learning model is an artificial neural network.

5. The method of claim 4, wherein the artificial neural network includes one or more hidden layers, the one or more hidden layers including a summation layer comprising a linear function and an activation layer comprising a sigmoid function.

6. The method of claim 4, wherein the artificial neural network is trained using a Levenberg-Marquardt algorithm and a Bayesian regularization backpropagation algorithm.

7. The method of claim 4, wherein a dataset comprising log data from one or more wells, seismic data from a seismic survey of a region that includes a location of the one or more wells, and a corresponding core sample dataset from the one or more wells are used to train and validate the artificial neural network, the log data and the seismic data representing input data processed by the artificial neural network, the core sample data representing a set of ground truth values corresponding to a set of predicted rock values.

8. The method of claim 7, wherein the dataset is split into a training dataset and a validation dataset, the training dataset used to train the artificial neural network, the validation dataset used to validate a set of outputs of the artificial neural network.

9. The method of claim 4, wherein the artificial neural network is retrained with new training data to update a set of weights corresponding to a nonlinear function of the artificial neural network.

10. A method for exploring a reservoir for determining material abundance, the method comprising:
obtaining log data from a well, wherein the well is located in a region;
obtaining seismic data from a seismic survey of the region;
processing the log data and the seismic data using a machine learning model to generate a representation of material abundance of the well; and
generating a pseudo-log of material abundance of the well based at least in part on the representation of material abundance of the well.

11. The method of claim 10, wherein the material abundance data represent an abundance of one or more minerals, wherein the one or more minerals include one or more rare earth elements.

12. The method of claim 10, wherein the machine learning model generates a continuous set of predicted material abundance data along the main axis of the well.

13. The method of claim 10, wherein the machine learning model is an artificial neural network.

14. The method of claim 13, wherein the artificial neural network includes one or more hidden layers, the one or more hidden layers including a summation layer comprising a linear function and an activation layer comprising a sigmoid function.

15. The method of claim 13, wherein the artificial neural network is trained using a Levenberg-Marquardt algorithm and a Bayesian regularization backpropagation algorithm.

16. The method of claim 13, wherein a dataset comprising log data from one or more wells, seismic data from a seismic survey of a region that includes a location of the one or more wells, and a corresponding core sample dataset from the one or more wells are used to train and validate the artificial neural network, the log data and the seismic data representing input data processed by the artificial neural network, the core sample data representing a set of ground truth values corresponding to a set of predicted rock values.

17. The method of claim 16, wherein the dataset is split into a training dataset and a validation dataset, the training dataset used to train the artificial neural network, the validation dataset used to validate a set of outputs of the artificial neural network.

18. The method of claim 13, wherein the artificial neural network is retrained with new training data to update a set of weights corresponding to a nonlinear function of the artificial neural network.
